(19) United States
(12) Patent Application Publication
(10) Pub. No.: US 2025/0033684 A1
(43) Pub. Date: Jan. 30, 2025

(54) RUMBLE SEAT ADAPTER

(71) Applicant: MONAHAN PRODUCTS, LLC, Rockland, MA (US)

(72) Inventors: Richard M. Bastien, Cumberland, RI (US); Luis Alejandro Canas, Stoughton, MA (US); Trung Q. Phung, Milton, MA (US)

(21) Appl. No.: 18/225,250

(22) Filed: Jul. 24, 2023

(51) Int. Cl. B62B 7/14

(52) U.S. Cl. CPC B62B 7/14

(57) ABSTRACT

According to at least one aspect of the present disclosure an adapter for a stroller is provided, the adapter comprising a mating feature including a recess; a post coupled to the mating feature and having an upper part configured to selectively nest within at least a portion of the recess, a lower part, and the post including a pivot axis located between the upper part and lower part, the post being configured to selectively pivot around the pivot axis; and a biasing mechanism configured to bias the post in a first position.

### BACKGROUND

Strollers, and similar devices, are used to transport young children and infants. Most strollers are four-wheeled devices having one or more fixed seats. The fixed number of seats limits the passenger (or carrying) capacity of a stroller, so that the passenger capacity of the stroller cannot be expanded to accommodate additional children or infants without getting a new stroller or fundamentally altering the physical structure of the stroller.

### SUMMARY

According to at least one aspect of the present disclosure an adapter for a stroller is provided, the adapter comprising a mating feature including a recess; a post coupled to the mating feature and having an upper part configured to selectively nest within at least a portion of the recess, a lower part, and the post including a pivot axis located between the upper part and lower part, the post being configured to selectively pivot around the pivot axis; and a biasing mechanism configured to bias the post in a first position.

In some examples, the mating feature further comprises an aperture configured to receive a connector latch. In some examples, the aperture is located along a central axis of the mating feature. In some examples, the mating feature further comprises one or more teeth. In some examples, in the first position, the upper part of the post is biased to protrude from a face of the mating feature such that at least a portion of the upper part is not flush with the mating feature. In some examples, the post is configured to pivot between the first position and a second position, and in the second position, the upper part does not protrude from a face of the mating feature. In some examples, the adapter further comprises a securing mechanism coupled to the mating feature, the securing mechanism being configured to selectively contact the post. In some examples, the securing mechanism further comprises a tab, the tab being configured to contact the lower post in a closed position. In some examples, in the closed position, the tab contacts the lower part of the post, pivoting the upper part of the post into the second position. In some examples, the upper part is within the recess in the mating feature.

According to at least one aspect of the present disclosure an adapter for a stroller is provided, the adapter comprising a shell having an inside and an outside; a securing mechanism coupled to the shell via a hinge and configured to pivot around a longitudinal axis of the hinge relative to the shell; a latch situated within the shell and configured to retain the securing mechanism when the securing mechanism is in a closed position; and a button configured to adjust a position of the latch.

In some examples, the securing mechanism further comprises a receptacle configured to receive at least a portion of the latch when the securing mechanism is in a closed position. In some examples, the receptacle, when in a closed position, is configured to fixedly connect with the latch. In some examples, the receptacle exerts a force on the latch when the receptacle has contacted but not retained the latch, the force biasing the latch into a retainable position. In some examples, the button is configured to release the latch based on movement of the button. In some examples, the shell further comprises a mating feature and the adapter further comprises a post configured to protrude from a face of the mating feature. In some examples, the securing mechanism further comprises a tab configured to contact the post when the securing mechanism is in a closed position. In some examples, the tab biases the post in the closed position such that the post is biased to not protrude from the face of the mating feature.

According to at least one aspect of the present disclosure an adapter for a stroller is provided, the adapter comprising a first adapter portion having a connector latch, and an actuation mechanism; and a second adapter portion having a mating feature configured to mate with the first adapter portion, a post configured to prevent mating of the second adapter portion with the first adapter portion in a first position and to permit mating the second adapter portion with the first adapter portion in a second position; and a securing mechanism hingedly coupled to the mating feature and configured to selectively bias the post into the second position.

In some examples, the post includes an upper part and a lower part, the upper part being biased to protrude from a face of the mating feature in the first position. In some examples, the securing mechanism includes a tab configured to contact and bias the lower part in the second position and to bias the post into the second position. In some examples, the mating feature further includes an aperture configured to receive the connector latch. In some examples, the actuation mechanism is configured to control a position of the connector latch to selectively decouple the connector latch from the second adapter portion. In some examples, the second adapter portion further comprises a latch configured to selectively mate with a receptacle of the securing mechanism. In some examples, the adapter further comprises a button configured to selectively decouple the latch from the receptacle.

### BRIEF DESCRIPTION OF THE DRAWINGS

Various aspects of at least one embodiment are discussed below with reference to the accompanying figures, which are not intended to be drawn to scale. The figures are included to provide an illustration and a further understanding of the various aspects and embodiments, and are incorporated in and constitute a part of this specification, but are not intended as a definition of the limits of any particular embodiment. The drawings, together with the remainder of the specification, serve to explain principles and operations of the described and claimed aspects and embodiments. In the figures, each identical or nearly identical component that is illustrated in various figures is represented by a like numeral. For purposes of clarity, not every component may be labeled in every figure. In the figures:

FIG. 1 illustrates an adapter from a front view according to an example;

FIG. 2 illustrates the adapter from a rear view according to an example;

FIG. 3 illustrates the adapter using a cutaway view according to an example;

FIG. 4 illustrates a relationship between a securing mechanism, post, and latch according to an example;

FIG. 5 illustrates a system including the adapter according to an example;

FIG. 6A illustrates the adapter coupled together with a connector according to an example;

FIG. 6B illustrates a cross-section view of the adapter coupled together with the connector according to an example;

FIG. 6C illustrates a partial side-view of the cross section of FIG. 6B according to an example;

FIG. 7A illustrates a view of a button and latch of the adapter according to an example;

FIG. 7B illustrates a second view of the button and latch of the adapter according to an example;

FIG. 8A illustrates a connector according to an example;

FIG. 8B illustrates a connector according to an example;

FIG. 8C illustrates a connector according to an example; and

FIG. 8D illustrates a connector according to an example.

### DETAILED DESCRIPTION

Strollers, such as baby-strollers, often have a fixed number of seats to accommodate infants. A stroller with a single seat, for example, can accommodate one infant normally, while a stroller with two seats can accommodate two infants, and so forth. When a need for additional seats arises—for example, when a new child is born or when baby-sitting, or in other circumstances—the owner of the stroller is forced to purchase a new stroller with a sufficient number of seats.

Aspects of elements of this disclosure are directed to a system and method for adding seats to a stroller without altering the stroller itself. In particular, an adapter is provided that can mate with a seat and with a stroller. For example, the adapter can securely connect to a plurality of types of seats, including at least a first type of baby seat (such as a stroller seat) and a second type of baby seat (such as a car seat). The adapter can also securely connect to a stroller. In examples presented herein, the adapter may connect to one seat at a time (of any type) and may simultaneously connect to a stroller.

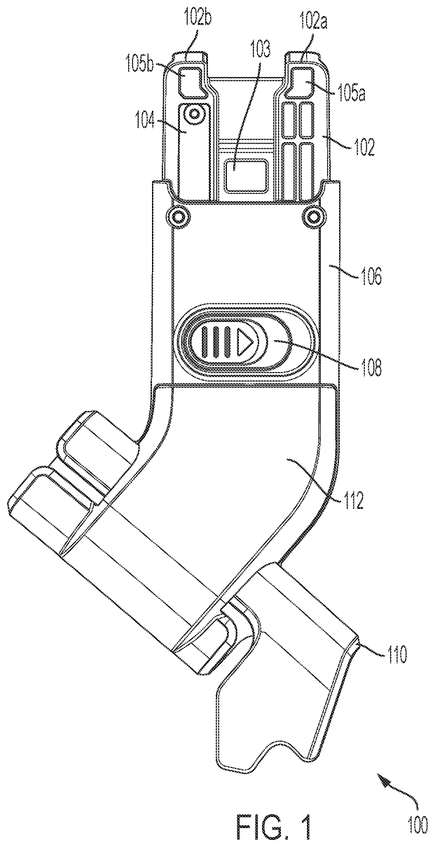

FIG. 1 illustrates an adapter 100 from a front view according to an example. The adapter 100 includes a seat mating feature 102, a post 104, a first body portion 106, a switch 108, a second body portion 110, and a securing mechanism 112. The adapter 100 is configured to mate with the stroller using the second body portion 110 and the securing mechanism 112, and to mate with a stroller seat using the seat mating feature 102. Mating feature 102 includes a first tooth 102a, a second tooth 102b, an aperture 103, a first receptacle 105a, and a second receptacle 105b.

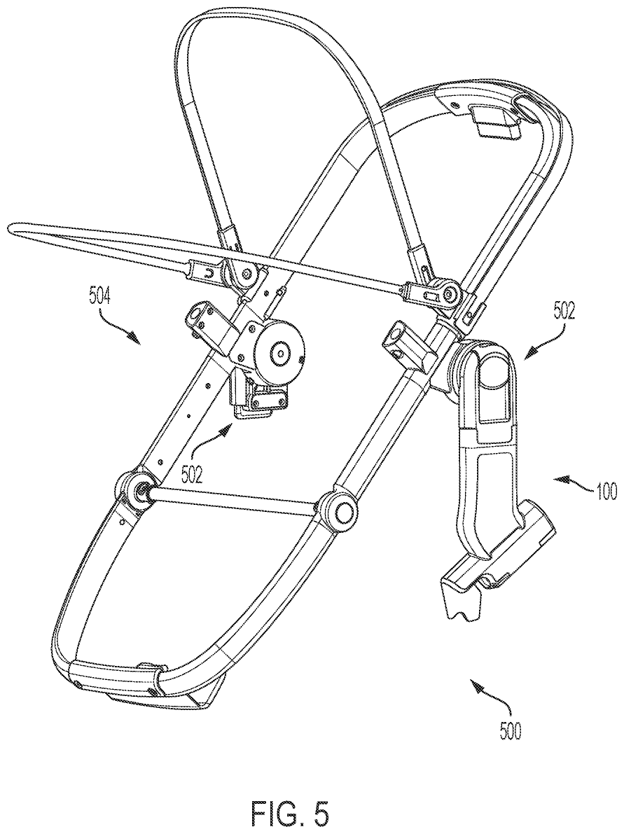

Mating feature 102 is configured to mate with one or more types of baby seat, including, for example, a stroller seat and/or a car seat. Mating feature 102 may be configured to mate with another adapter (such as rumble seat connector 502 of FIG. 5) as a means of mating with a seat. In some examples, mating feature 102 is a male mating feature configured to be received by a female mating feature. In some examples, mating feature 102 may be a female mating feature configured to receive a male mating feature. Mating feature 102 includes an aperture 103 and also holds or contains part of post 104. Mating feature 102 may include one or more teeth 102a, 102b, which may be protrusions configured to mate with a seat or an adapter (such as rumble seat connector 502 of FIG. 5). In some examples, mating feature 102 is at least thick enough to fully retain post 104 in some positions of post 104. For example, post 104 may have a length and a cross section defined by a width and height. Post 104 may be aligned such that a longitudinal axis of post 104 corresponds to the length of post 104. Then, mating feature 102 may be thick enough that the cross section (width by height) of post 104 may fit entirely within mating feature 102 in at least one position, such that no portion of post 104 protrudes from mating feature 102.

Aperture 103 is configured to receive a mating feature for a first type of seat, for example a stroller seat, such that when the first type of seat is placed on mating feature 102, the first type of seat is secured to mating feature 102 and thus secured to adapter 100.

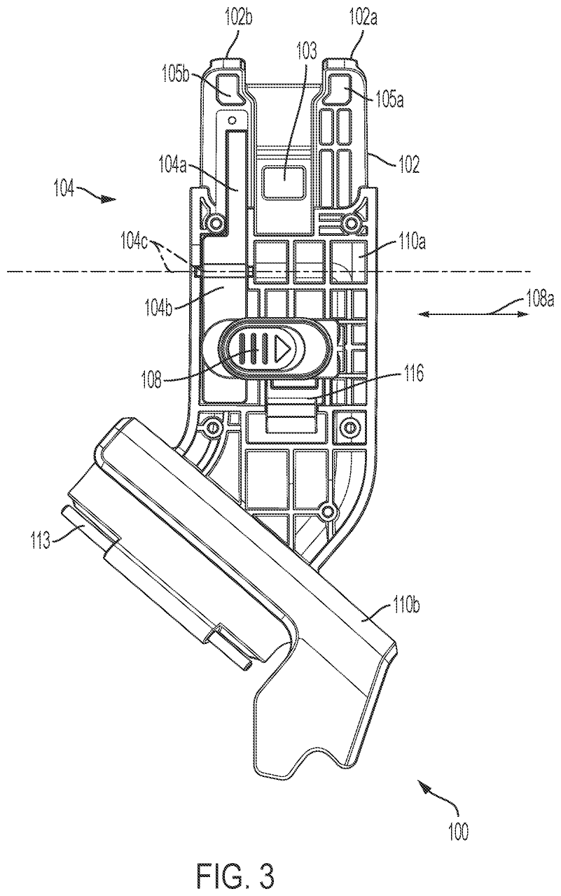

Post 104 is configured to prevent mating feature 102 from mating with a seat, such as the first type or second type of seat, unless securing mechanism 112 is fully secured. In some examples, post 104 protrudes away from the surface of mating feature 102 opposite the side of button 108 (that is, post 104 protrudes in the opposite direction of the point of view of the figure—e.g., into the plane of the paper). When securing mechanism 112 is fully secured, a lever (discussed more with respect to FIG. 3) causes post 104 to recede into a position where post 104 no longer protrudes from mating feature 102 and/or is flush with the face of mating feature 102.

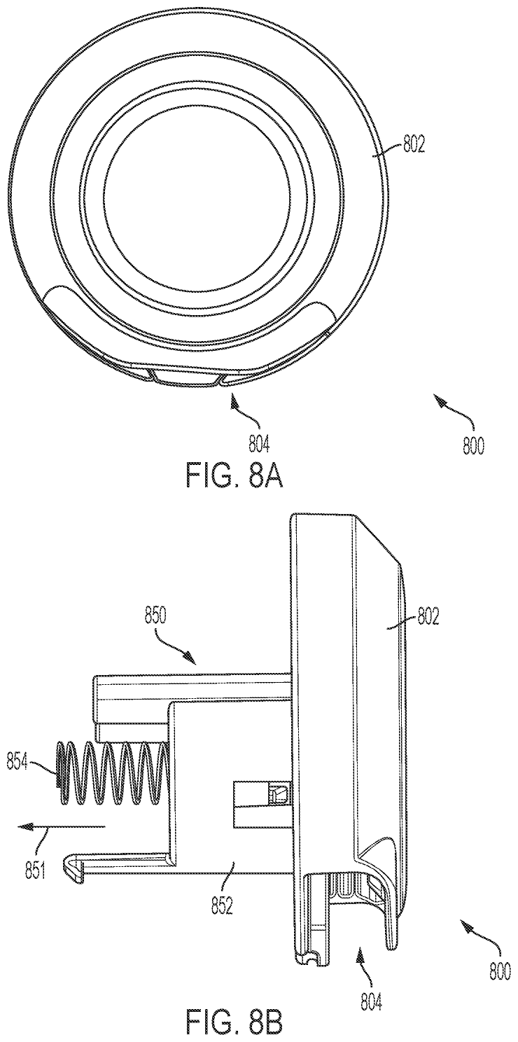

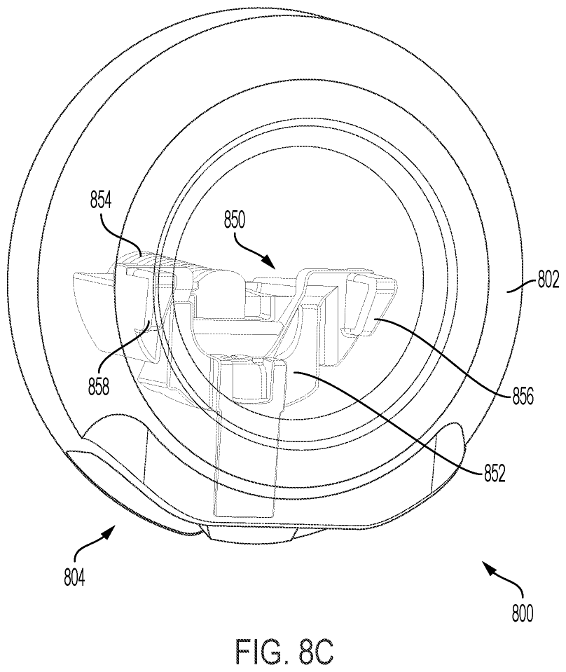

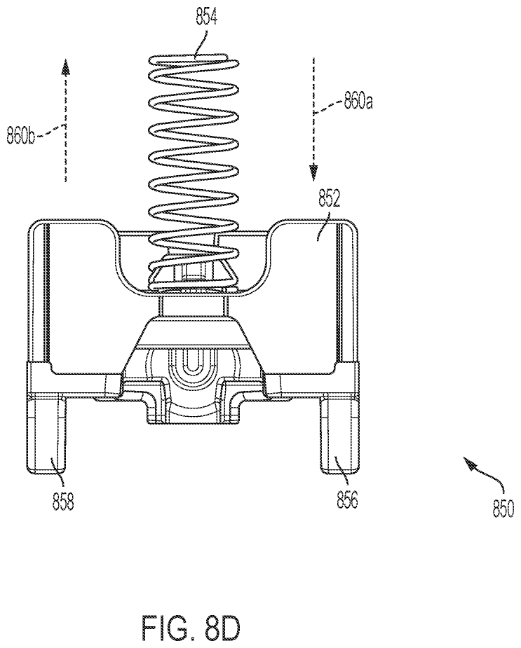

Receptacles 105a, 105b may be configured to receive securing portions of the second type of seat, for example a car seat. Receptacles 105a, 105b may be “holes” through mating feature 102, or recesses configured to retain a latch, or similar device. A second type of connector, configured for the second type of seat, is discussed with respect to FIGS. 8A and 8B.

First body portion 106 connects to second body portion 110. First body portion 106 may be secured to second body portion 110 using any method (screws, bolts, sonic welding, and so forth), or first body portion 106 and second body portion 110 may be a single piece. The first body portion 106 includes an aperture large enough to accommodate switch 108. In some examples, first body portion 106 does not move relative to second body portion 110.

Switch 108 is coupled to securing mechanism 112. When securing mechanism 112 is in the closed position, a latch within adapter 100 is caught by a portion of securing mechanism 112, such that securing mechanism 112 is kept in the closed position. By moving switch 108, the latch is disengaged and securing mechanism 112 is released and may be moved into the open position.

Second body portion 110 is coupled to first body portion 106. In some examples, second body portion 110 may include mating feature 102. In some examples, first body portion 106 may form a shell that houses portions of post 104 and other internal components.

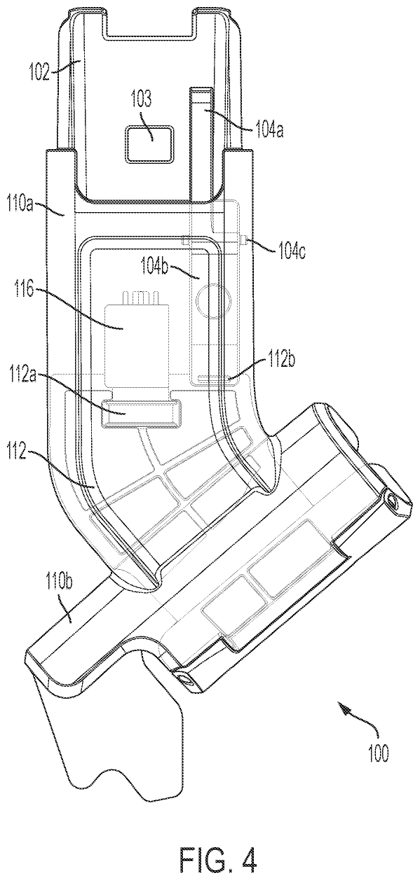

Securing mechanism 112 is hingedly coupled to second body portion 110. In some examples, securing mechanism 112 can pivot around a longitudinal axis 114 of a hinge 113. When securing mechanism 112 is not secured in place (i.e., when it is in an open position, which will be discussed with respect to FIG. 4), post 104 may be biased in a position that protrudes from mating feature 102. When securing mechanism 112 is secured in place (i.e., when it is in the closed position, which will be discussed with respect to FIG. 4), securing mechanism 112 places pressure on the lever portion of post 104, biasing post 104 to be flush with mating feature 102.

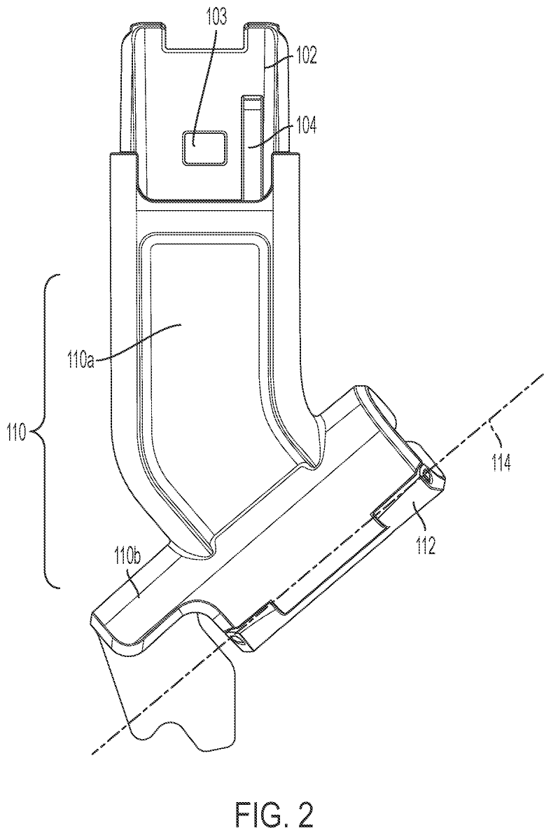

FIG. 2 illustrates adapter 100 from a rear view according to an example. FIG. 2 shows a pivot axis 114 for securing mechanism 112, however, first body portion 106 is not visible in this view. FIG. 2 also illustrate a first section 110a and a second section 110b of second body portion 110.

FIG. 3 shows a cutaway view of adapter 100 according to an example. The cutaway view reveals various internal workings of adapter 100.

Post 104 includes upper post 104a, lower post 104b, and post axis 104c. Securing mechanism 112 includes a tab 112b (shown in FIG. 4) that, when securing mechanism 112 is in the closed position, exerts force on lower post 104b. In some examples, the tab 112b orthogonally (that is, at a right angle) extends from a surface of the securing mechanism 112. The force exerted on lower post 104b by the tab 112b of securing mechanism 112 causes post 104 to pivot around post axis 104c. Because the force applied on lower post 104b is directed into the page (i.e., away from the point of view relative to FIG. 3), upper post 104a moves in the opposite direction (i.e., out of the page or toward the point of view relative to FIG. 3). As a result, upper post 104a of post 104 is pivoted into adapter 100 such that post 104 is flush with (or no longer protruding from) the face of mating feature 102. In a position where post 104 no longer protrudes from the face of mating feature 102, adapter 100 may now couple with a rumble seat or similar device.

Button 108 can slide laterally in the directions indicated by the arrow 108a. After being pushed in, sliding button 108 to the right (relative to the point of view of FIG. 3), operates latch 116, causing the latch to slide away from securing mechanism 112 (not shown). Latch 116 can mate with securing mechanism 112 to hold securing mechanism 112 in place. Button 108 thus allows securing mechanism 112 to be secured in the closed position or released from the closed position.

FIG. 4 illustrates the relationship between securing mechanism 112, post 104, and latch 116.

Securing mechanism 112 includes a receptacle 112a and a tab 112b. Receptacle 112a is large enough to mate with at least a portion of latch 116 when securing mechanism 112 is in the closed position. In some examples, latch 116 may be beveled or tapered such that securing mechanism 112 and receptacle 112a can push latch 116 into a position where, once securing mechanism 112 is in or approximately in the closed position, latch 116 can enter receptacle 112a and hold securing mechanism 112 in place. In some examples, receptacle 112a is formed by a loop forming an aperture to receive latch 116.

In some examples, tab 112b contacts the lower post 104b as the securing mechanism 112 is placed into the closed position. Tab 112b pushes lower post 104b, causing post 104 to pivot around pivot axis 104c, thus causing upper post 104a to no longer protrude from mating feature 102. When post 104 no longer protrudes, adapter 100 can mate with a rumble seat or similar device.

FIG. 5 illustrates a system 500 including adapter 100, a corresponding first type of connector 502 (“connector 502”) for a first type of seat, connector 502 being configured to mate with adapter 100, and a rumble seat frame 504. Mating feature 102 of adapter 100 mates with connector 502. In some examples, mating feature 102 inserts into connector 502 (that is, in some examples, adapter 100 has the male mating feature, e.g., mating feature 102, while the connector 502 has a corresponding female mating feature). In other examples, connector 502 inserts into the adapter 100. Other modes of connection are also possible.

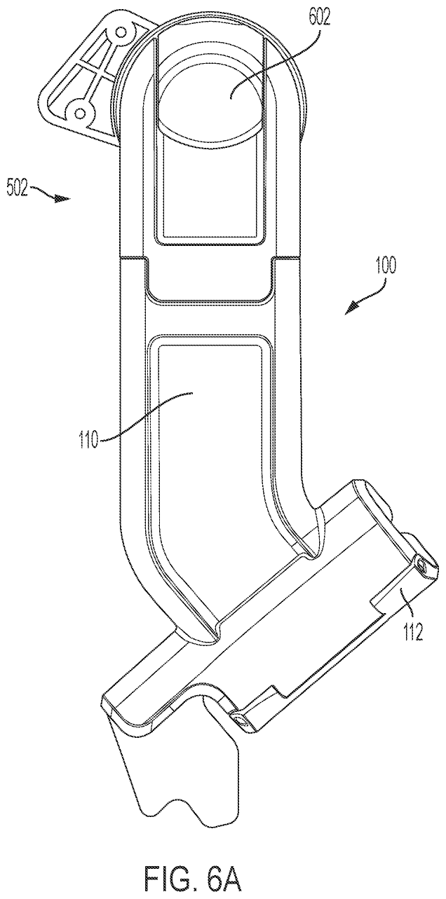

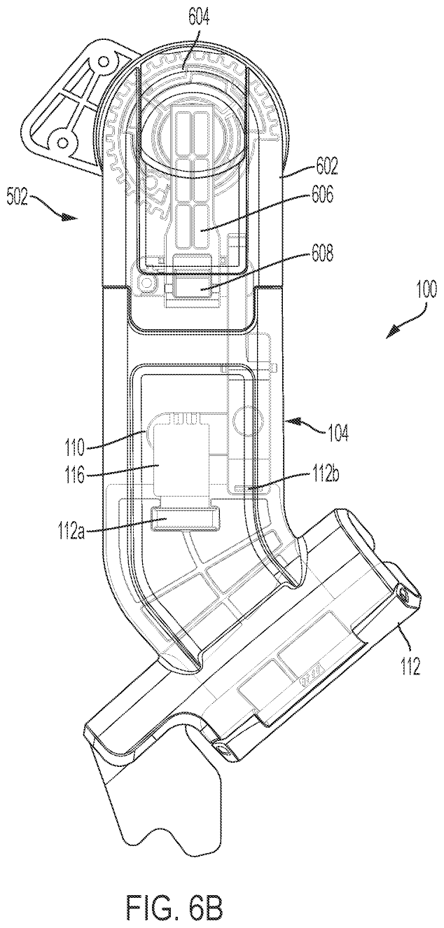

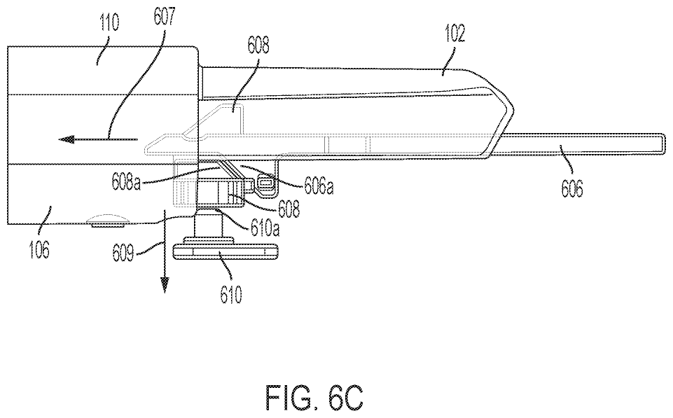

FIG. 6A illustrates adapter 100 coupled together with connector 502. Connector 502 has a shell 602 that covers the internal mechanisms of the connector 502.

FIG. 6B illustrates a cross-sectioned view of adapter 100 coupled together with connector 502. Connector 502 includes a gear assembly 604, an actuation mechanism 606, and a connector latch 608. Gear assembly 604 is coupled to actuation mechanism 606, and actuation mechanism 606 is slidably coupled to the connector latch 608.

When connector 502 and adapter 100 are mated together, post 104 is flush with (i.e., not protruding from) the face of mating feature 102. In some examples, when post 104 is protruding from the face of mating feature 102, post 104 protrudes too far to fit within shell 602 of connector 502. Instead, post 104 contacts with an outer surface of shell 602, preventing mating feature 102 from fully mating and/or mating at all with connector 502.

FIG. 6C illustrates a partial side-view of the cross section of FIG. 6B, emphasizing the relationship between actuation mechanism 606 and connector latch 608.

As shown, connector latch 608 is in aperture 103 of mating feature 102. With connector latch 608 in place through aperture 103, connector 502 and adapter 100 are held together in a fixed or at least semi-fixed manner. When it is desired to disconnect adapter 100 from connector 502, actuator 606 is slid in the direction of arrow 607. In some examples, actuator 606 moves responsive to gear assembly 604 moving (that is, the gears turning or rotating).

As actuator 606 moves in the direction of arrow 607, actuator cam 606a of actuator 606 presses against latch cam 608a of connector latch 608. The pressure of actuator cam 606a against latch cam 608a causes connector latch 608 to slide in the direction of arrow 609. Connector latch 608 is configured to rest around prong 610a of support 610. That is, in some examples, connector latch 608 includes a hole that is large enough to accommodate prong 610a of support 610. Support 610 prevents connector latch 608 from shifting in unwanted directions during operation of actuator 606. In some examples, a spring is wrapped around prong 610a to bias connector latch 608 in the direction opposite arrow 609, thus ensuring connector latch 608 remains stationary within aperture 103 when adapter 100 and connector 502 are mated together.

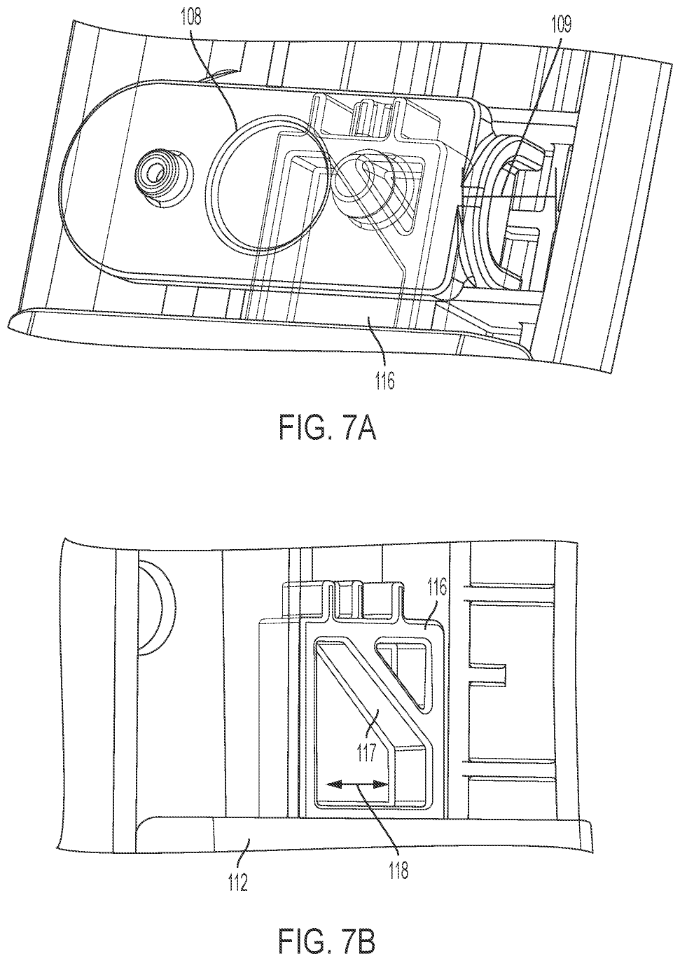

FIGS. 7A and 7B illustrate the function of button 108 and latch 116 in greater detail according to an example.

FIG. 7A illustrates a view of button 108 and latch 116 with button 108 presented in a semi-transparent manner according to an example. In FIG. 7A, button 108 is configured to travel to the left or right to the extent permitted by the distance defined by channel 109. Button 108 is also slidably connected to latch 116 along an angled surface 117 (shown in FIG. 7B).

As button 108 traverses the width of the channel 109, a protrusion from the button 108 that contacts to the angled surface 117 moves from the left to the right or right to the left as indicated by an arrow 118. The movement of the protrusion against angled surface 117 pushes latch 116 away from securing mechanism 112, which then allows securing mechanism 112 to pivot freely. That is, at least a portion of the force from moving button 108 directed to the right (with respect to FIG. 7B) is translated by angled surface 117 into upward (with respect to FIG. 7B) force that moves latch 116 away from securing mechanism 112.

FIGS. 8A-8D illustrate a second type of connector 800 according to an example. Connector 800 may be used to connect adapter 100 to a different kind of seat compared to connector 502 of FIG. 5. In some examples, connector 502 of FIG. 5 may connect a stroller seat to adapter 100 and connector 800 of FIG. 8A may connect a car seat to adapter 100.

FIG. 8A illustrates connector 800 from a first angle according to an example. Connector 800 includes an outer shell 802 and a slot 804. Slot 804 is an opening in the outer shell 802. Slot 804 is configured to receive mating feature 102. That is, mating feature 102 may be inserted into outer shell 802 via slot 804. Thus, adapter 100 may mate to connector 800 by mating feature 102 entering outer shell 802 via slot 804.

FIG. 8B illustrates connector 800 from a second angle according to an example. Outer shell 802 and slot 804 remain visible, now shown from a side-perspective relative to the perspective of FIG. 8A. Also shown are components of connection mechanism 850 (discussed and shown in full in FIG. 8C), including spring 854 and body 852. Mating feature 102 may be inserted into slot 804, where first receptacle 105a and second receptacle 105b may be secured in place by first latch 856 and second latch 858 (shown in FIG. 8C). When mating feature 102 is inserted into outer shell 802, connection mechanism 850 is pressed by mating feature 102 in the direction of arrow 851. Spring 854 is compressed as connection mechanism 850 moves in the direction of arrow 851. When mating feature 102 is removed from outer shell 802, spring 854 decompresses and pushes connection mechanism 850 back to its original position.

FIG. 8C illustrates connector 800 (“connector 800”) according to an example. In contrast to FIGS. 8A and 8B, outer shell 802 is shown as transparent so that connection mechanism 850 can be seen.

Connector 800 includes an outer shell 802 and a connection mechanism 850. Outer shell 802 includes a slot 804. Connection mechanism 850 includes a body 852, a spring 854, a first latch 856, and a second latch 858.

Outer shell 802 is coupled to connection mechanism 850, in some examples to body 852 and spring 854. Body 852 is coupled to spring 854 at a first location, to first latch 856 at a second location, and to second latch 858 at a third connection.

Outer shell 802 may be hollow on the inside, to accommodate connection mechanism 850 and mating feature 102. Slot 804 allows for mating feature 102 to enter outer shell 802 and couple to connection mechanism 850.

Spring 854 biases body 852 of connection mechanism 850 into a first position. First latch 856 is configured to mate with first receptacle 105a and second latch 858 is configured to mate with second receptacle 105b when mating feature 102 is inserted through slot 804 into outer shell 802. Force exerted by teeth 102a, 102b on first latch 856 and second latch 858 cause body 852 to slide in a direction opposite the biasing force exerted by spring 854 (e.g., in the direction of arrow 851) until first receptacle 105a and second receptacle 105b are adjacent to first latch 856 and second latch 858, at which point spring 854 pushes first latch 856 and second latch 858 into first receptacle 105a and second receptacle 105b respectively, locking adapter 100 to connector 800.

FIG. 8D illustrates connection mechanism 850 from a top-down perspective according to an example. FIG. 8D adds two arrows, a first arrow 860a and a second arrow 860b. First arrow 860a shows the direction of the force exerted by spring 854 on body 852 relative to body 852. Second arrow 860b illustrates the direction of the force mating feature 102 exerts on body 852. The force corresponding to second arrow 860b may be greater than the force corresponding to the first arrow 860a for mating feature 102 to mate with connector 800.

Having thus described several aspects of at least one embodiment, it is to be appreciated various alterations, modifications, and improvements will readily occur to those skilled in the art. Such alterations, modifications, and improvements are intended to be part of, and within the spirit and scope of, this disclosure. Accordingly, the foregoing description and drawings are by way of example only.

Examples of the methods and systems discussed herein are not limited in application to the details of construction and the arrangement of components set forth in the following description or illustrated in the accompanying drawings. The methods and systems are capable of implementation in other embodiments and of being practiced or of being carried out in various ways. Examples of specific implementations are provided herein for illustrative purposes only and are not intended to be limiting. In particular, acts, components, elements and features discussed in connection with any one or more examples are not intended to be excluded from a similar role in any other examples.

Also, the phraseology and terminology used herein is for the purpose of description and should not be regarded as limiting. Any references to examples, embodiments, components, elements or acts of the systems and methods herein referred to in the singular may also embrace embodiments including a plurality, and any references in plural to any embodiment, component, element or act herein may also embrace embodiments including only a singularity. References in the singular or plural form are not intended to limit the presently disclosed systems or methods, their components, acts, or elements. The use herein of “including,” “comprising,” “having,” “containing,” “involving,” and variations thereof is meant to encompass the items listed thereafter and equivalents thereof as well as additional items.

References to “or” may be construed as inclusive so that any terms described using “or” may indicate any of a single, more than one, and all of the described terms. In addition, in the event of inconsistent usages of terms between this document and documents incorporated herein by reference, the term usage in the incorporated features is supplementary to that of this document; for irreconcilable differences, the term usage in this document controls.

What is claimed is:

1. An adapter for a stroller comprising:
a mating feature including a recess;
a post coupled to the mating feature and having
an upper part configured to selectively nest within at least a portion of the recess,
a lower part, and
the post including a pivot axis located between the upper part and lower part, the post being configured to selectively pivot around the pivot axis; and
a biasing mechanism configured to bias the post in a first position.

2. The adapter of claim 1 wherein the mating feature further comprises an aperture configured to receive a connector latch.

3. The adapter of claim 2 wherein the aperture is located along a central axis of the mating feature.

4. The adapter of claim 1 wherein the mating feature further comprises one or more teeth.

5. The adapter of claim 1 where, in the first position, the upper part of the post is biased to protrude from a face of the mating feature such that at least a portion of the upper part is not flush with the mating feature.

6. The adapter of claim 1 where the post is configured to pivot between the first position and a second position, and in the second position, the upper part does not protrude from a face of the mating feature.

7. The adapter of claim 1 further comprising a securing mechanism coupled to the mating feature, the securing mechanism being configured to selectively contact the post.

8. The adapter of claim 7 wherein the securing mechanism further comprises a tab, the tab being configured to contact the lower post in a closed position.

9. The adapter of claim 8 where, in the closed position, the tab contacts the lower part of the post, pivoting the upper part of the post into the second position.

10. The adapter of claim 9 wherein the upper part is within the recess in the mating feature.

11. An adapter for a stroller comprising:
a shell having an inside and an outside;
a securing mechanism coupled to the shell via a hinge and configured to pivot around a longitudinal axis of the hinge relative to the shell;
a latch situated within the shell and configured to retain the securing mechanism when the securing mechanism is in a closed position; and
a button configured to adjust a position of the latch.

12. The adapter of claim 11 wherein the securing mechanism further comprises a receptacle configured to receive at least a portion of the latch when the securing mechanism is in a closed position.

13. The adapter of claim 12 wherein the receptacle, when in a closed position, is configured to fixedly connect with the latch.

14. The adapter of claim 12 wherein the receptacle exerts a force on the latch when the receptacle has contacted but not retained the latch, the force biasing the latch into a retainable position.

15. The adapter of claim 11 wherein the button is configured to release the latch based on movement of the button.

16. The adapter of claim 11 wherein the shell further comprises a mating feature and the adapter further comprises a post configured to protrude from a face of the mating feature.

17. The adapter of claim 16 wherein the securing mechanism further comprises a tab configured to contact the post when the securing mechanism is in a closed position.

18. The adapter of claim 17 wherein the tab biases the post in the closed position such that the post is biased to not protrude from the face of the mating feature.

19. An adapter for a stroller comprising:
a first adapter portion having
a connector latch, and
an actuation mechanism; and
a second adapter portion having
a mating feature configured to mate with the first adapter portion,
a post configured to prevent mating of the second adapter portion with the first adapter portion in a first position and to permit mating the second adapter portion with the first adapter portion in a second position; and
a securing mechanism hingedly coupled to the mating feature and configured to selectively bias the post into the second position.

20. The adapter of claim 19 wherein the post includes an upper part and a lower part, the upper part being biased to protrude from a face of the mating feature in the first position.

21. The adapter of claim 20 wherein the securing mechanism includes a tab configured to contact and bias the lower part in the second position and to bias the post into the second position.

22. The adapter of claim 19 wherein the mating feature further includes an aperture configured to receive the connector latch.

23. The adapter of claim 19 wherein the actuation mechanism is configured to control a position of the connector latch to selectively decouple the connector latch from the second adapter portion.

24. The adapter of claim 10 wherein the second adapter portion further comprises a latch configured to selectively mate with a receptacle of the securing mechanism.

25. The adapter of claim 24 further comprises a button configured to selectively decouple the latch from the receptacle.
